(19) United States
(12) Patent Application Publication
(10) Pub. No.: US 2008/0028978 A1
(43) Pub. Date: Feb. 7, 2008

(54) Water-based asphalt emulsion-based coatings, compositions, manufacture and applications for use

(75) Inventors: Timothy D. Twining, Houston, TX (US); David G. Caston, Al-Khobar (SA); Michael E. Quinlan, La Porte, TX (US)

Correspondence Address: GORDON G. WAGGETT, P.C., 550 WESTCOTT STREET, SUITE 350, HOUSTON, TX, 77007-5099, US

(73) Assignee: Blak Tuf-Stuf, Inc.

(21) Appl. No.: 11/657,419

(22) Filed: Jan. 23, 2007

Related U.S. Application Data
(60) Provisional application No. 60/761,104, filed on Jan. 23, 2006.
(60) Provisional application No. 60/761,105, filed on Jan. 23, 2006.

(51) Int. Cl. B05D 1/34; E04B 1/74

(52) U.S. Cl. 106/14.05; 252/62; 427/426

(57) ABSTRACT

The present invention relates generally to water based polymer modified asphalt emulsions, their composition, their manufacture and their uses. For example, there is disclosed a method for coating a structure or surface by applying a polymer modified asphalt emulsion coating to the structure or surface. The coating is preferably applied as a two component spray comprising an aqueous catalyst and an aqueous asphalt emulsion. The aqueous catalyst can employ an aqueous acid, preferably citric acid, but can also use an aqueous catalyst comprising an aqueous solution of calcium chloride. Preferably each of the two components are directed through separate ports on a spray nozzle so that they mix together on the fly external to the nozzle before contacting the surface to be coated. This methodology can be used to sound insulate structures, to encapsulate friable materials, to weather coat a structure, and to create a non-corrosive waterproof monolithic membranes.

### CROSS-REFERENCE TO RELATED APPLICATIONS

This application claims the benefit of the filing dates of U.S. Provisional Patent Application No. 60/761,105 filed Jan. 23, 2006 (Confirmation No. 4812) and U.S. Provisional Patent Application No. 60/761,104 filed Jan. 23, 2006 (Confirmation No. 4833).

### STATEMENT REGARDING FEDERALLY SPONSORED RESEARCH OR DEVELOPMENT

Not Applicable.

### BACKGROUND OF THE INVENTION

The present invention relates generally to a range of water based polymer modified asphalt emulsions, their composition, their manufacture and their uses, including military uses, such as creating a sound-deadening coating on military vehicles, including ships and submines, to possibly distort or evade radar and/or sonar signals as well as a bullet resistant and impact absorbing coating that can be readily and quickly applied to any surface, or used in the manufacture of armored vehicles or personnel apparel to absorb concussion and contain explosive forces, both alone and in conjunction with other bullet or concussion resistant materials.

Water based polymer modified asphalt emulsions have been used in combination with a salt-based emulsion breaker (catalyst) to form an asphaltic coating used in roofing and below ground concrete waterproofing applications.

The primary catalyst used in application of these products in the past for these applications has been calcium chloride. This catalyst is inherently corrosive and creates problems due to its corrosive nature, particularly when used in an application on a metal substrate.

These two component systems (i.e., the aqueous asphalt emulsion component and the aqueous catalyst component) can be spray applied from a double nozzle spray gun where the two parts are fed separately into and exit separately from the nozzle so that the mixing of the two parts occurs approximately one (1) foot outside of the exit from the spray gun nozzles and prior to contacting the application surface. These emulsions are de-emulsified at the mix point upon contact with the catalyst, leaving behind on the application surface an asphalt/polymer mix. The water from the emulsions is released, resulting in a monolithic membrane or coating of any desired thickness which is fully bonded to the application surface. Various nozzle designs can be employed to achieve the desired spray application, but preferably the nozzle directs the spray in a substantially thin rectangular or triangular pattern to permit a broad swath of spray coverage from the nozzles. Preferably, the nozzle is attached to a hand held wand that can be used by a person, although mechanical, remotely controlled spray application is possible as well. Full curing of this membrane or coating (i.e. evaporation of all water from the product) is achieved in one or more days, depending on temperature, humidity and thickness of application.

Due to the corrosive nature of the salt (i.e., calcium chloride—CaCl₂), the use of such prior art asphalt emulsion-based coatings would not be safe for use with metal products, such as, for example, pipelines, valves, storage tanks, metal roofs, and metal-based land, air or marine vehicles or structures. Additionally, the use of CaCl₂ could also create potential pollution issues with respect to the salt component being exposed to water. As such, there exists a need to provide an alternative catalyst where the use of calcium chloride would not be desired.

In the area of marine coatings, historically, anti fouling paints are ablative (releasing a strong poison continually over an extended period of time into the water) by design to kill marine growth such as algae and marine borers such as barnacles. However, this ablation of toxins into the water system has presented numerous environmental problems and ablative anti fouling bottom paints containing tri-butal tin (“TBT”) were outlawed worldwide in 2003. There are continuing efforts to also outlaw cupreous oxides and other ablative anti fouling paints for similar reasons. As such, there exists a need to provide an alternative marine anti fouling paint that achieves the desired goal of repelling marine growth on a desired surface that is exposed to a marine (salt or fresh water) environment without the deleterious effects experienced with prior anti fouling paints.

### SUMMARY OF THE INVENTION

In a preferred embodiment of the present invention, there is disclosed a method for protecting a surface comprising the step of applying a polymer modified asphalt emulsion coating to the surface to be coated. The uses of the coating are varied, such as, for sound proofing, waterproofing, corrosion protection, weather protection, encapsulation of friable materials, creation of monolithic membranes. The coating can be sprayed on as a two component system using a two component spray gun system, or can be premixed for application using conventional application techniques, such as application with a paint brush, paint roller, trowel or single component spray gun.

In a preferred embodiment of the present invention, there is disclosed a method for sound insulating a structure comprising the step of applying a polymer modified asphalt emulsion coating to desired surfaces of the structure to be sound insulated. The coating can preferably be applied as a two component spray comprising the additional steps of: feeding an aqueous asphalt emulsion to one side of a two-sided spray nozzle; feeding an aqueous catalyst to the other side of the two-sided spray nozzle; directing the nozzle toward a surface of the structure to be coated; and spraying the aqueous asphalt and catalyst through the nozzle to provide mixing of same external to the nozzle, preferably while on the fly. In a preferred embodiment, the aqueous catalyst comprises an aqueous acid, preferably citric acid, but can also use, for new applications disclosed herein, an aqueous catalyst comprising an aqueous solution of calcium chloride.

These sound insulation techniques have application in the sound deadening of military vehicles as part of their passive defense system. For example, the engine rooms and other interior locations of sailing vessels, ships and submarines could be coated with this material to provide sound detection avoidance. Additionally, the entire exterior surface of a submarine could coated as well, and this coating might also provide a defense to detection by absorbing or otherwise interfering with the sonar/radar signals directed at the vehicle. In this method for sound insulating, all manner of military vehicles could be treated, such as, a marine vessel selected from the group comprising, boats, ships, battleships, buoy tenders, aircraft carriers, amphibious assault ships, amphibious command ships, amphibious transport dock, command ships, torpedo boats, dock landing ships, air cushioned landing craft, mechanical and utility landing craft, destroyers, cutters, cruisers, military cargo ships, gun boats, frigates, ice breakers, submarines and other marine vessels. Likewise, military structures, such as barrack, or other structures containing equipment or people, could be coated.

Additionally, the citric acid catalyst avoids the use of corrosive calcium chloride catalysts that could damage the vehicle or vessel. Additionally, this coating can be readily applied to existing structures, such as barracks or other installations to provide sound deadening, and as described later, an element of protection from bullets or other projectiles.

In another preferred embodiment of the present invention there is described a method of encapsulating a friable material comprising the step of applying a polymer modified asphalt emulsion coating, much like described above, to the friable material. The friable material might include asbestos or asbestos-containing materials; lead paint or lead-containing materials; or other solid materials that can pose a risk to human health, animal health or aquatic life if allowed to become airborne, dust-borne, water-borne, ingestible or loose as a result of the chipping, crumbling, crushing or other damage to such friable material.

In yet another preferred embodiment, there is disclosed a method for weather coating a structure comprising the step of applying a polymer modified asphalt emulsion coating, as described herein, to desired surfaces of the structure to be weather coated. Where metal is to be coated, the acid is preferably a mild acid, such as citric acid. Additionally, the coating can contain a non-skid material and then be coated with one or more elastomeric paint coatings. Also, prior to coating surfaces according to embodiments of the present invention, it may be desired to prepare the surfaces by cleaning, drying, sandblasting, and/or application of a thin layer of an aqueous asphalt emulsion.

Using the teachings of this invention, there can also be employed a method of making a non-corrosive waterproof monolithic membrane comprising the following steps: feeding an aqueous polymer modified asphalt emulsion to a surface; feeding an aqueous acid catalyst to the surface; mixing the aqueous asphalt emulsion at substantially the same time with the aqueous catalyst on the surface to cause the de-emulsification of the asphalt emulsion; and curing the de-emulsified asphalt emulsion. In a preferred embodiment of this method, the acid used is citric acid. Also, in an alternative preferred embodiment, the aqueous asphalt emulsion is fed to the surface by feeding the aqueous asphalt emulsion through a first side of a two-sided spray nozzle to create a first stream exiting the nozzle. The aqueous catalyst is fed to the surface by feeding the aqueous catalyst through a second side of the two-sided spray nozzle to create a second stream exiting the nozzle. Additionally, in a preferred embodiment, the mixing step takes place by intermixing the first and second streams after the streams exit from the nozzle and prior to contacting the application surface.

Using the methodologies of the present invention, virtually any structure or surface can be coated, and the membrane can be created directly on a desired location of the structure. In another embodiment of the present invention, it is desired to create a membrane layer that can be cut into various shapes and widths, like narrow strips, and rolled for later use in wrapping surfaces, such as pipes (e.g., a tape-like rolled membrane form), or covering large surfaces, such as a floor or balcony (e.g., a carpet-like rolled membrane form).

There is also disclosed a preferred composition of matter comprising the product of the de-emulsification with an aqueous acid catalyst of an aqueous polymer modified asphalt emulsion. A preferred embodiment of this product is created using a citric acid catalyst to de-emulsify the polymer modified aqueous asphalt emulsion.

In yet another preferred embodiment of the present invention, there is described a non-corrosive waterproof monolithic membrane manufactured according to the processes described herein.

Also, the present invention includes the use of polymer modified asphalt emulsion-based coatings to readily, quickly and economically create a surface coating that is resistant to the penetration of bullets or other projectiles while being relatively light in weight. In this embodiment, the spray-on coating could be used as, e.g., a coating on vehicles, shields, headgear, structures and personal protective clothing; and on the exterior of barges and docks. Additionally, the coating may reduce or eliminate corrosion or electrolysis when used as a barrier coating on marine vessels or structures. Also, the present invention includes the use of polymer modified asphalt emulsion-based coatings to readily, quickly and economically create a surface coating that is resistant to abrasion and to the penetration of projectiles while being relatively light in weight. In this embodiment, the spray-on coating could be used as, e.g., a coating on the exterior of barges and docks. Additionally, the coating may reduce or eliminate corrosion or electrolysis when used as a barrier coating on marine vessels or structures.

### DETAILED DESCRIPTION OF PREFERRED EMBODIMENTS

As set out herein, the present application relates to the use of a novel non-corrosive, benign catalyst in creating polymer modified asphaltic coatings that could be advantageously used with any metal surface where such coating was desired without the risk that the coating would damage the integrity of the underlying metal surface.

Applicant has discovered that the use of benign acids, such as citric acid, can be successfully employed as a catalyst for these two component asphalt emulsion coating systems, thereby avoiding the detrimental effects of calcium chloride. In a preferred embodiment, it has been found that citric acid, either liquid in all concentrations or in granular form dissolved in water in a range of concentrations up to the full solubility of the citric acid can be employed to advantage. This aqueous citric acid catalyst produces the same result as the aqueous calcium chloride catalyst, but without calcium chloride's corrosive residue, thus making the end product and the liquid residue more acceptable for all uses, particularly for use in all applications on metal, such as metal roofing and marine applications of all types. Thus, although any of the catalysts could be employed for the new uses of these coatings as discussed herein, the citric acid catalyst presents preferred characteristics when applied to metal surfaces. Other acids could be used to advantage as a catalyst, but the citric acid is preferred for its benign characteristics, particularly when being used in an aqueous solution that is sprayed.

Additionally, Applicant has found that, as an alternative to spraying on these asphalt emulsion-based coatings using a two-nozzle spray gun system, sheets or rolls of this asphalt emulsion-based coating material can be manufactured for use in covering a surface. In this manufacturing process, the two component asphalt emulsion/catalyst system is sprayed onto a surface (preferably one that is essentially inert to the adhesiveness of the resulting coating) in desired width, length and thickness. The resulting sheets can be further processed, such as by cutting them into long narrow strips of varying widths that can be rolled up (with an inert paper-like divider) for use in later coating a desired surface. For example, the rolls could be manufactured or cut to a desired width, e.g., between 6″ to 1′ in width, desired thickness, e.g. ⅛″ in thickness, and of desired lengths for use in, e.g., wrapping exposed industrial pipelines. These sizes could be offered in standard or custom widths, lengths and thicknesses. Additionally, wide rolls of this material could be created, much like with carpeting, for application to large, flat surfaces to create waterproof and, when properly coated, non-skid surfaces or walkways. In a preferred embodiment, the physical characteristics of the tape (such as its elasticity, memory, tackiness, etc.) is such that when the tape is applied over a pipe surface, it can be stretched over the surface, in a spiral wrapping fashion, to allow one edge of the tape to overlap with the other edge of the tape thereby creating a tight seal or bond between each overlapping layer of the coating, and allowing the memory forces to “grip” the wrapped pipe. Additionally, these types of sheet-like asphalt emulsion-based layers could be used as a component to flooring systems, and as decorative floor tiles and the like.

In yet another preferred embodiment of the present invention, the asphalt-emulsion based coating of the present invention can include within it a non-skid material, such as a granular material that would serve to make the exposed surface of the coating “non-skid” in nature, thereby providing an enhanced safety feature on the coated surface. The granular material could be selected from any of the non-skid materials, and depending on the application, could be designed so that walking barefoot on the surface would not be uncomfortable. Additionally, the non-skid material could be a light-reflective material. Additionally, as an alternative embodiment, a surface could be first coated with the asphalt emulsion-based coating of the present invention and then coated with a separate non-skid material or surface, such as an elastomeric material containing such non-skid materials and/or texturing materials and/or color pigments. Thus, in preferred embodiment, a water-proofing layer of asphalt emulsion-based coating can be used on, e.g., an outdoor sports track, patios, decks, walkways and balconies.

Additionally, as desired, the asphalt emulsion-based coating system of the present invention could include a desired pigment, or later be coated with a pigment-containing product, such as a paint or other pigmented coating. The coating could also be impregnated with a material useful in the avoidance of detection, such that a surface sprayed or coated with such coating might be less detectable by, e.g., radar, sonar or vision.

The asphalt emulsions of the present invention are preferably anionic, range from 40-80% solids and are made from asphalts which preferably range from 5 PEN to 140 PEN. A wide range of emulsifiers can be employed, including, for example tall oils, fatty acids, wood resins—lignosulfatones, depending on the characteristics and specifications of the particular asphalt being used to make the emulsion.

The polymers used in the asphalt emulsion, also preferably anionic, may preferably be chloroprenes, styrene butadiene rubber (SBR), styrene butadiene styrene (SBS) or a blend of two or all three of these. The blend ratio of the asphalt emulsion components may preferably range anywhere from 70% polymer/30% asphalt emulsion to 1% polymer/99% asphalt emulsion. The polymer component may also preferably range from 100% chloroprene to a blend ratio of chloroprene with as much as 50% SBR or SBS, or an SBR/SBS blend in the desired ratio. In a preferred embodiment, only SBS and/or SBR are incorporated into the product. Additionally, the polymers used in the asphalt emulsions of the present invention may be nonionic.

The components of this two component system are both applied at ambient temperature, using either a high pressure or low pressure spray system. The polymers significantly improve the physical characteristics of the asphalt emulsion following application, increasing toughness, ductility and softening point; improving low temperature flexibility and aging performance; and reducing the brittle point. As will be know in the art, adjustments in the asphalt polymer component composition can provide different desired characteristics of the final coating, such as, e.g., increased softness, increased hardness or elasticity.

Additionally, as an alternative to a two-component spray-on system, one can mix the polymer modified asphalt emulsion with an aqueous catalyst that serves as a thickener of the polymer modified asphalt emulsion to create a single component material that can be prepackaged in a sealed container for later application using, e.g., a single component spray gun, paint brushes, rollers or trowels. In this embodiment, preferred aqueous catalysts include sodium silicate and butyl namate, but other aqueous catalysts/thickeners can be employed.

Applicant has also found that these types of asphalt emulsions can be used in new applications, including, sound proofing; providing shock resistant protective layers; providing bullet resistant protective layers; encapsulation of hazardous material, such as asbestos fibers and lead paint; coating of pipes and pipelines; and marine coatings both above and below the waterline, including non ablative non toxic, environmentally safe anti-foulant coating for marine vessels, such as, e.g., boats, ships, and the like and marine structures, such as, e.g., offshore platforms, bulkheads, and the like. As such, the present invention relates to the use of asphalt-emulsion based coatings used in novel applications.

For soundproofing, Applicant has found that when the product is applied to any surface, the sound transmission through the combined coating/application surface is reduced by as much as 100%, depending upon the thickness of the product application. For example, when applied at 205 mils thickness on a metal surface 30 mils thick, the sound reduction on the coated side is 98%; and on the non-coated side, 76%. When applied at 250 mils thickness on the inside or outside of the metal or plastic cowling on a motor or engine, a substantial decibel sound reduction is achieved. Given that this material may be applied as a spray, it is quick and easy to spray on as a sound-proofing layer of this asphalt emulson-based coating to any desired thickness, typically in one application. Thus, any setting desiring sound-proofing, such as a recording studio, sleeping quarters or workplace environment can employ this invention to advantage. Additionally, compliance with many OSHA workplace noise requirement issues can be addressed effectively by using the sound insulative coating according to the present invention. For example, the walls of engine/mechanical equipment rooms, engine housings, mechanical machinery and the like could be coated, either during construction, or as a retrofit, by spraying same with the preferred asphalt emulsion-based coatings of the present invention. The present invention also has particular application in the sound-deadening of military vehicles. The coating can be used to insulate sounds created on ships, transport vehicles, submarines and the like. The coating can serve multiple purposes on such vehicles, including providing a weather resistant protective coating, as well as sound deadening.

Asbestos insulation and other asbestos-containing products, such as roofing materials, have been used in the past but are known to create a serious health risk to humans exposed to any airborne asbestos fibers. As such, asbestos abatement is required where asbestos is found. However, removal of asbestos insulation or asbestos-containing products can create a risk of asbestos fiber release, and the removal and disposal of asbestos is expensive. As such, the present invention can be employed to advantage by encapsulating the asbestos with the spray-on (or tape over) asphalt emulsion-based coatings of the present invention, with or without the addition of synthetic fabric, without disturbing the asbestos, thereby abating its danger while maintaining the insulative properties of the asbestos and avoiding the high cost of asbestos removal. Likewise, the present invention can also be used in similar fashion to coat surfaces containing lead paint, thereby eliminating the removal costs and risks associated with the presence and abatement of lead paint.

Additionally, the present invention also finds useful application as an under coating and sound insulating material for vehicles, such as cars, trucks, buses, trains, aircraft, and marine vessels. Given that these applications typically involve the coating of metal, the embodiment using Applicant's novel citric acid (non-calcium chloride) catalyst component can be employed to advantage. Of particular utility is the ability of the present invention's use in the marine industry, such as deck coating and the coating of other external surfaces of marine vessels, both above and below the waterline, to provide a non ablative anti fouling coating.

The asphalt emulsion coatings of the present invention also have substantial shock or concussion absorbing qualities and are very durable in thicker applications of over one inch; and can be suitably employed in applications such as bumpers for barges, docks, etc.

Also, the present invention includes the use of polymer modified asphalt emulsion-based coatings to readily, quickly and economically create a surface coating that is resistant to the penetration of bullets or other projectiles while being relatively light in weight. In this embodiment, the spray-on coating could be used as a coating on vehicles, shields, headgear, structures and personal protective clothing.

In another preferred embodiment of the present invention, the surface to be coated with the asphalt emulsion-based coating is first treated by, e.g., sandblasting or other means of paint removal, acid etching, degreasing and washing, cleaning and drying or applying a thin layer of the aqueous asphalt emulsion prior to applying the asphalt emulsion-based coating.

While the apparatus and methods of this invention have been described in terms of preferred embodiments, it will be apparent to those of skill in the art that variations may be applied to the process described herein without departing from the concept and scope of the invention. For example, cationic and/or anionic asphalt emulsions, produced from appropriate emulsifiers, and cationic and/or anionic polymers, in conjunction with the appropriate cationic or anionic catalyst, may be used without departing from the concept and scope of the invention. All such similar substitutes and modifications apparent to those skilled in the art are deemed to be within the scope and concept of the invention.

We claim:

1. A method for sound insulating a equipment and/or a structure comprising the step of applying a polymer modified asphalt emulsion coating to desired surfaces of the equipment and/or structure to be sound insulated.

2. The method of claim 1 wherein said coating is applied as a two component spray comprising the additional steps of:
a. feeding an aqueous asphalt emulsion to one side of a two-sided spray nozzle;
b. feeding an aqueous catalyst to the other side of the two-sided spray nozzle;
c. directing said nozzle toward a surface of the structure to be coated; and
d. spraying such aqueous asphalt and catalyst through such nozzle to provide mixing of same external to said nozzle prior to contacting the application surface.

3. The method of claim 2, wherein said aqueous catalyst comprises an aqueous acid.

4. The method of claim 3, wherein said acid is citric acid.

5. The method of claim 2, wherein said aqueous catalyst comprises an aqueous solution of calcium chloride.

6. The method for sound insulating of claim 1 wherein the structure is a marine vessel selected from the group comprising, boats, ships, battleships, buoy tenders, aircraft carriers, amphibious assault ships, amphibious command ships, amphibious transport dock, command ships, torpedo boats, dock landing ships, air cushioned landing craft, mechanical and utility landing craft, destroyers, cutters, cruisers, military cargo ships, gun boats, frigates, ice breakers, submarines and other marine vessels.

7. The method for sound insulating of claim 1 wherein the structure is a temporary or permanent barracks or other outpost designed to house people and equipment.

8. The method for sound insulating of claim 1 wherein the structure is an aircraft.

9. The method for sound insulating of claim 1 wherein the structure is a land vehicle, including, jeep, humvee, armored personnel carriers, tanks, and the like.

10. A method of encapsulating a friable material comprising the step of applying a polymer modified asphalt emulsion coating to the friable material.

11. The method of claim 10 wherein said coating is applied as a two component spray comprising the additional steps of:
a. feeding an aqueous asphalt emulsion to one side of a two-sided spray nozzle;
b. feeding an aqueous catalyst to the other side of the two-sided spray nozzle;
c. directing said nozzle toward a surface of the friable material to be coated; and
d. spraying such aqueous asphalt and catalyst through such nozzle to provide mixing of same external to said nozzle and prior to contacting the application surface.

12. The method of claim 11, wherein said aqueous catalyst comprises an aqueous acid.

13. The method of claim 12, wherein said acid is citric acid.

14. The method of claim 11, wherein said aqueous catalyst comprises an aqueous solution of calcium chloride.

15. The method of claim 10, wherein the friable material comprises asbestos or asbestos-containing materials; lead paint or lead-containing materials; or other solid materials that can pose a risk to human health, animal health or aquatic life if allowed to become airborne, dust-borne, water-borne, ingestible or loose as a result of the chipping, crumbling, crushing or other damage to such friable material.

16. A method for protecting a surface comprising the step of applying a polymer modified asphalt emulsion coating to the surface to be coated.

17. The method of claim 16 wherein said coating is applied as a two component spray comprising the additional steps of:
a. feeding an aqueous asphalt emulsion to one side of a two-sided spray nozzle;
b. feeding an aqueous catalyst to the other side of the two-sided spray nozzle;
c. directing said nozzle toward a surface of the structure to be coated; and
d. spraying such aqueous asphalt and catalyst through such nozzle to provide mixing of same external to said nozzle prior to contacting the application surface.

18. The method of claim 17, wherein said aqueous catalyst comprises an aqueous acid.

19. The method of claim 18, wherein said acid is citric acid.

20. The method of claim 17, wherein said coating contains a non-skid material.

21. The method of claim 17 comprising the additional first step of preparing said desired surfaces by sandblasting or other means.

22. The method of claim 17 comprising the additional first step of preparing said desired surfaces by applying a thin layer of an aqueous asphalt emulsion.

23. A method of making a non-corrosive waterproof monolithic membrane comprising the following steps:
a. feeding an aqueous asphalt emulsion to one side of a two-sided spray nozzle;
b. feeding an aqueous catalyst to the other side of the two-sided spray nozzle;
c. directing said nozzle toward a surface of the structure to be coated; and
d. spraying such aqueous asphalt and catalyst through such nozzle to provide mixing of same external to said nozzle prior to contacting the application surface, causing de-emulsification of the asphalt emulsion and formation of a membrane.

24. The method of claim 23 wherein said acid is citric acid.

25. The method of claim 23 wherein said step of feeding said aqueous asphalt emulsion to said surface is accomplished by feeding said aqueous asphalt emulsion through a first side of a two-sided spray nozzle to create a first stream exiting said nozzle; wherein said step of feeding said aqueous catalyst to said surface is accomplished by feeding said aqueous catalyst through a second side of said two-sided spray nozzle to create a second stream exiting said nozzle; and wherein said mixing step takes place by intermixing said first and said second streams after said streams exit from said nozzle and prior to contacting the application surface.

26. The method of claim 23 wherein said surface is a structure to be coated, and said membrane is created directly on a desired location of said structure.

27. The method of claim 23 wherein said surface is a structure capable of removably receiving said membrane.

28. The method of claim 23 comprising the additional steps of removing said membrane from said surface, and prior to or after said removing step, cutting said membrane into desired lengths and widths.

29. A composition of matter comprising the product of the de-emulsification with an aqueous acid catalyst of an aqueous polymer modified asphalt emulsion.

30. The composition according to claim 29 wherein said acid is citric acid.

31. The composition according to claim 29 wherein said asphalt emulsion and said catalyst are anionic.

32. The composition according to claim 29 wherein said asphalt emulsions range from 40% to 80% solids.

33. The composition according to claim 29 wherein said asphalts range from 5 PEN to 140 PEN.

34. The composition according to claim 29 wherein said emulsifiers used with said asphalt emulsions can be selected from a wide spectrum of emulsifiers, including tall oils, fatty acids, wood resins, and lignosulfatones.

35. The composition according to claim 29 wherein said polymers are also anionic and may be selected from the group comprising chloroprenes, styrene butadiene rubber (SBR), styrene butadiene styrene (SBS) or a blend of these three.

36. The composition according to claim 29 wherein the blend ratio of the components may be anywhere from 70% polymer/30% asphalt emulsion to 1% polymer/99% asphalt emulsion.

37. The composition according to claim 35 wherein the polymer component may range from 100% chloroprene to a blend ratio of chloroprene with as much as 50% SBR or SBS, or an SBR/SBS blend in the desired ratio.

38. A non-corrosive waterproof monolithic membrane manufactured according to the following process:
a. feeding an aqueous asphalt emulsion to one side of a two-sided spray nozzle;
b. feeding an aqueous catalyst to the other side of the two-sided spray nozzle;
c. directing said nozzle toward a surface of the structure to be coated; and
d. spraying such aqueous asphalt and catalyst through such nozzle to provide mixing of same external to said nozzle prior to contacting the application surface, causing de-emulsification of the asphalt emulsion and formation of a membrane.

39. The membrane of claim 38 wherein said acid is citric acid.

40. The membrane of claim 38 wherein said step of feeding said aqueous asphalt emulsion to said surface is accomplished by feeding said aqueous asphalt emulsion through a first side of a two-sided spray nozzle to create a first stream exiting said nozzle; wherein said step of feeding said aqueous catalyst to said surface is accomplished by feeding said aqueous catalyst through a second side of said two-sided spray nozzle to create a second stream exiting said nozzle; and wherein said mixing step takes place by intermixing said first and said second streams after said exiting from said nozzle prior to contacting the application surface.

41. The membrane of claim 38 wherein said surface is a structure to be coated, and said membrane is created directly on a desired location of said structure.

42. The membrane of claim 38 wherein said surface is a structure capable of removably receiving said membrane.

43. The membrane of claim 42 comprising the additional steps of removing said membrane from said surface, and prior to or after said removing step, cutting said membrane into desired lengths and widths.

44. The method of claim 16, wherein said coating comprises a mixture of the polymer modified asphalt emulsion with an aqueous catalyst that serves as a thickener of the polymer modified asphalt emulsion to create a single component material that can be prepackaged in a sealed container for later application using a trowel, brush, roller or single component spray gun.

45. The method of 44, wherein said aqueous catalysts comprise sodium silicate or butyl namate.
